(19) United States
(12) Patent Application Publication
(10) Pub. No.: US 2015/0317450 A1
(43) Pub. Date: Nov. 5, 2015

(54) PROCESS SIMULATION MODEL DISCOVERY SYSTEM OF OUTPATIENT CONSULTATION AND PROCESS SIMULATION MODEL DISCOVERY METHOD

(71) Applicant: UNIST ACADEMY-INDUSTRY RESEARCH CORPORATION, Ulsan (KR)

(72) Inventors: Minseok SONG, Ulsan (KR); Minsu CHO, Ulsan (KR)

(21) Appl. No.: 14/700,215

(22) Filed: Apr. 30, 2015

(30) Foreign Application Priority Data
Apr. 30, 2014 (KR) 10-2014-0052792

(51) Int. Cl. G06F 19/00; G06F 17/50; G06F 17/10

(52) U.S. Cl. CPC G06F 19/3437; G06F 17/10; G06F 17/5009; G06F 19/327

(57) ABSTRACT

A process simulation model discovery system of outpatient consultation according to one aspect of the present invention, comprising: an event log collection unit which collects an event log data; a data pre-processing unit which removes a duplicate value and an outlier from the log data; a data analyzing unit which derives from a process from the log data and analyzes a working time; and a process simulation modeling unit which generates a process simulation model, wherein the data analyzing unit includes a process derivation module which derives a process corresponding to a work from a log data and a working time analyzing module which derives a working time for a patient from the log data.

### CROSS-REFERENCE TO RELATED APPLICATION

This application claims priority to and the benefit of Korean Patent Application No. 10-2014-0052792 filed in the Korean Intellectual Property Office on Apr. 30, 2014, the entire contents of which are incorporated herein by reference.

### FIELD OF THE INVENTION

The present invention relates to a process simulation model discovery system and a process simulation model discovery method. In particular, the present invention relates to a process simulation model discovery system of outpatient consultation and a process simulation model discovery method.

### DESCRIPTION OF THE RELATED ART

A process mining is a research of extracting useful knowledge from event logs provided by the information system. The process mining provides a new technique for process discover, monitoring, improvement and the process mining is applicable to the processes in various fields. By using the process mining, the user can discover useful information from business process records taking place in the business process. The information discovered by using the process mining can be used for business process innovation of enterprises. Due to development of the internet and computing technology, and an increase of the data, fields and scale of the market to which the process mining is applied are expected to be gradually expanded.

In this regard, Korea Patent No. 10-0500329 discloses a workflow mining system and method to evaluate, analyze, and diagnose past performance results of a process or task by applying the process mining techniques to a workflow log data accumulated in the operating process of the workflow system.

A hospital information system consists of various systems such as PMS (Practice Management System), EMR (Electronic Medical Record), CPOE (Computerized Physician Order Entry), PACS (Picture Archiving Communication System), and LIS (Laboratory Information System). All data related to a patient such as treatment, medicine manufacture, examination, personal information, and the like are recorded through these systems. However, each information system is difficult for analysis of the integrated process view since the each information system saves only partial information of the patient in each database. Thus, it is necessary to build a single integrated database on the basis of the history of each information system.

### CONTENTS OF THE INVENTION

### Problem to be Solved

The purpose of the present invention is to provide a system and a device for easily and quickly deriving a highly reliable model in deriving a process simulation model of outpatient consultation.

### Means for Solving Problem

A process simulation model discovery system of outpatient consultation according to one aspect of the present invention, comprising: an event log collection unit which collects an event log data; a data pre-processing unit which removes a duplicate value and an outlier from the log data; a data analyzing unit which derives from a process from the log data and analyzes a working time; and a process simulation modeling unit which generates a process simulation model, wherein the data analyzing unit includes a process derivation module which derives a process corresponding to a work from a log data and a working time analyzing module which derives a working time for a patient from the log data. Moreover, the process simulation model discovery system of outpatient consultation according to one aspect of the present invention comprises a module which automatically generates a process simulation model by integrating the previously extracted information.

Wherein the data pre-processing unit includes a missing value processing module which processes a missing value in which a data is missed, and the missing value processing module generates a missing value by modifying a worker's ID to be equal to an ID of department in which the worker is included.

Moreover, the process derivation module connects one work to another work through a movement line by identifying the flow of all patients shown in logs and sets up only logs connected with more than a predetermined number of a movement line as a process.

Furthermore, the data analyzing unit includes an arrival rate analyzing module which derives an arrival rate (AR) that is a difference between a reservation time and an arrival time, and the arrival rate analyzing module may derive the arrival rate by using the following equation.

AR=πᵣₜ(eᵢ)−πₐ(π_{trace}(1))

Wherein, πᵣₜ(eᵢ) is a reservation time, and πₐ(π_{trace}(1)) is a working time when a patient who arrives at the hospital firstly performs.

Moreover, the working time analyzing module derives an operation time (OT) for a patient from each doctor's treatment completion time recorded in the system, the operation time (OT) may satisfy the following equation.

OT=πₑₜ(c_{dk})−πₑₜ(c_{dj})

Wherein, πₑₜ(c_{dk}) is the ‘d’ operation processing time against the ‘k’ patient, πₑₜ(c_{dj}) is the ‘d’ operation processing time against the ‘j’ patient, and the ‘j’ patient is a patient treated just before the ‘k’ patient.

Furthermore, the working time analyzing derives a waiting time (WT) that is a patent's waiting time for the treatment, and the waiting time (WT) satisfies the following equation.

WT=πₑₜ(c_{dj})−πₑₜ(c_{ck})

Wherein, πₑₜ(c_{dj}) is the ‘d’ operation processing time against the ‘j’ patient, πₑₜ(C_{ck}) is the ‘c’ operation processing time against the ‘k’ patient, and the ‘c’ operation is an operation performed to the ‘k’ patient just before the ‘d’ operation.

Various analysis are performed by deriving a simulation model based on the derived process model, distribution of patients, each operation processing time, and a waiting time.

A process simulation model discovery method of outpatient consultation according to another aspect of the present invention, comprising: event log collecting which collects an event log data; data pre-processing which removes a duplicate value and an outlier from the log data; data analyzing which derives from a process from the log data and analyze a working time; and process simulation modeling which generates a process simulation model, wherein the wherein the data analyzing includes process deriving which derives a process corresponding to a work from a log data and working time analyzing which derives a working time for a patient from the log data.

Wherein the data pre-processing includes a missing value processing which processes a missing value in which a data is missed, and the missing value processing may generate a missing value by modifying a worker's ID to be equal to an ID of department in which the worker is included.

Furthermore, the process deriving may connect one log to another log through a movement line and set up only logs connected with more than a predetermined number of a movement line as a process.

Moreover, the data analyzing includes an arrival rate analyzing which derives an arrival rate (AR) that is a difference between a reservation time and an arrival time, and the arrival rate (AR) may satisfy the following equation.

AR=πᵣₜ(eᵢ)−πₐ(π_{trace}(1))

Wherein, πᵣₜ(eᵢ) is a reservation time, and πₐ(π_{trace}(1))πᵣₜ(eᵢ) is a working time when a patient who arrives at the hospital firstly performs.

Moreover, the working time analyzing derives an operation time (OT), and the operation time (OT) may satisfy the following equation.

OT=πₑₜ(c_{dk})−πₑₜ(c_{dj}),

Wherein, πₑₜ(c_{dk}) is the ‘d’ operation processing time against the ‘k’ patient, is πₑₜ(c_{dj}) the ‘d’ operation processing time against the ‘j’ patient, and the ‘j’ patient is a patient treated just before the ‘k’ patient.

Furthermore, the working time analyzing derives a waiting time (WT), and the waiting time (WT) may satisfy the following equation.

WT=πₑₜ(c_{dj})−πₑₜ(c_{ck})

Wherein, πₑₜ(c_{dj}) is the ‘d’ operation processing time against the ‘j’ patient, πₑₜ(c_{ck}) is the ‘c’ operation processing time against the ‘k’ patient, and the ‘c’ operation is an operation performed to the ‘k’ patient just before the ‘d’ operation.

### Effects of the Invention

A process simulation model discovery system and a process simulation model discovery method according to an embodiment of the present invention may quickly derive a highly reliable model by having a process derivation module and a working time analyzing module.

### BRIEF DESCRIPTION OF THE DRAWINGS

FIG. 1 is a configuration diagram of a process simulation model discovery system according to an embodiment of the present invention.

FIG. 2 is a flow diagram of a process simulation model discovery system according to an embodiment of the present invention.

FIG. 3A is a diagram connected with an event and a log record, and FIG. 3B is a diagram of a process derived by a process deriving module according to an embodiment of the present invention.

FIG. 4 is a graph of an operation time derived by a working time analyzing module according to an embodiment of the present invention.

FIG. 5A is a graph showing a change of the average reservation waiting time according to increasing the number of patients, and FIG. 5B is a graph showing a change of the average reservation waiting time according to increasing treatment processing time.

### DETAILED DESCRIPTION

Hereinafter, embodiments of the present invention will be described in detail with reference to the drawings so that a person having ordinary skill in the art can readily be carried out. However, the present invention may be embodied in many different forms and should not be construed as limited to the embodiments set forth herein. Description and extraneous part was omitted in order to clearly describe the present invention in the drawings, and same reference numerals were used to same or similar elements throughout the specification.

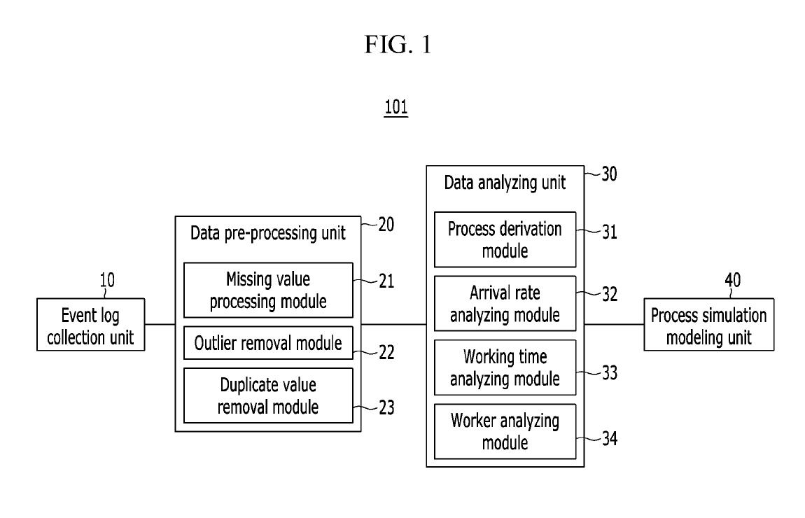

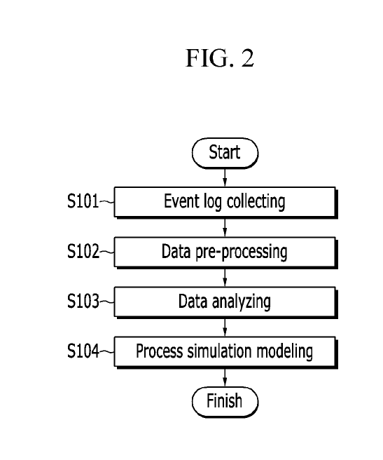

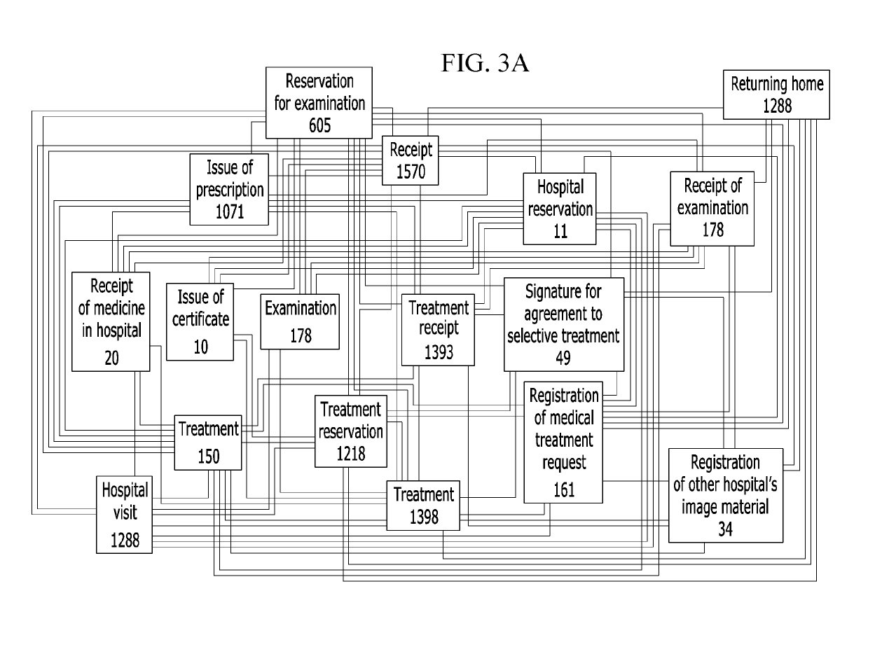

FIG. 1 is a configuration diagram of a process simulation model discovery system according to an embodiment of the present invention, and FIG. 2 is a flow diagram of a process simulation model discovery system according to an embodiment of the present invention.

Referring to FIG. 1 and FIG. 2, the process simulation model discovery system (101) according to the embodiment comprises an event log collection unit (10), a data pre-processing unit (20), a data analyzing unit (30), and a process simulation modeling unit (40).

The event log collection unit (10) collects an event log for a particular task that is recorded in the information system. A log data such as patient's reservation time, patient's time, operation time, injection time, treatment time, or the like is saved in the hospital information system. The event log collection unit (10) integrates the database stored in the hospital information system and creates a data for analysis (an event log).

The data pre-processing unit (20) processes a data to enhance the accuracy and validity of the extracted log data. The data pre-processing unit (20) may include a missing value processing module (21), an outlier removal module (22), and a duplicate value removal module (23).

When a data related to the worker's information is missed, the missing value processing module (21) may substitute a missed worker's ID for ID of the department by equally modifying the worker's ID and the ID of the department in which the worker is included. Moreover, the missing value processing module (21) may supplement the missed worker's ID by deriving a worker performing the operation at a given time in consideration of the correlation with other data.

The outlier removal module (22) removes data out of the upper and lower outlier criteria based on the working required time. The outlier criteria may be set in various ways according to the type of the log data. For instance, a patent's data that corresponds to the upper and lower 5% based on the total amount of time spent on hospital may be excluded from the analysis.

Due to the nature of the hospital, some patients may be admitted to hospital too early or visit the hospital twice or more. As a result, the total required time is maximized, and error may occur. The outlier removal module (22) removes the data causing the error to improve the accuracy of the log data.

Meanwhile, the duplicate value removal module (23) removes a duplicate value if some works are duplicately recorded. For instance, in case of the work such as inspection, receipt, reservation, two or more works are performed and received at the same time in many cases. In such a case, the number of works recorded at the same time is increased, thus a data analysis may be difficult and the resulting noise may occur. Therefore, the duplicate value removal module (23) integrates these operations and implements the process of removing duplicate values.

The data analyzing unit (30) derives from a process from a log data and analyzes a working time. The data analyzing unit (30) includes a process derivation module (31), an arrival rate analyzing module (32), a working time analyzing module (33), and a worker analyzing module (34).

The process derivation module (31) derives a process for a simulation from a log data. The process derivation module (31) may derive a process through an alpha mining method, a heuristic mining method, or the like. However, a mining technique directly designed is applied to the process derivation module (31) according to an embodiment of the present invention. The process derivation module (31) connects one log to another log through a movement line and sets up only logs connected with more than a predetermined number of a movement line as a process.

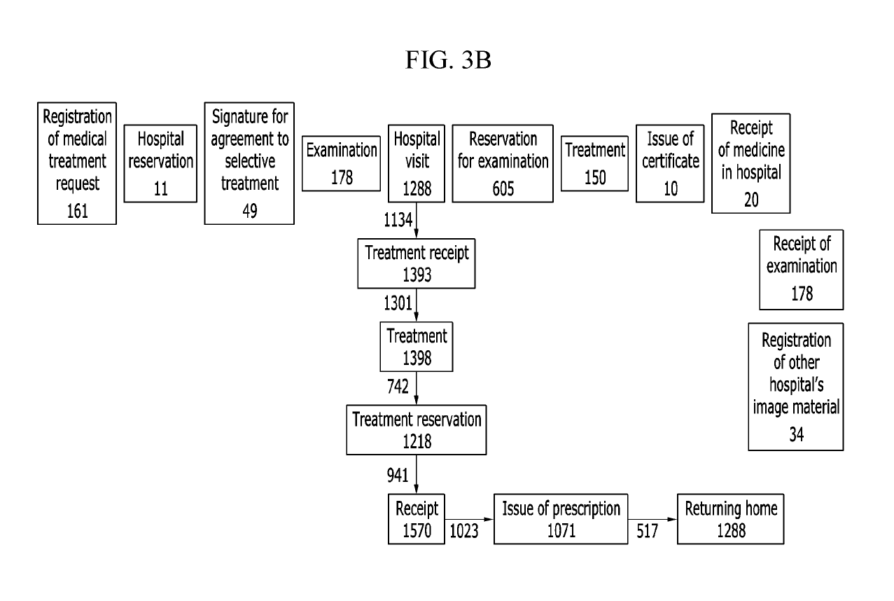

As described in FIG. 3A, a complex relation is derived when connecting logs in the order of time. Only important processes can be derived as shown in FIG. 3B by displaying only more than the predetermined limit standard of logs in the complex relation. FIG. 3B derives more than 500 times of working transfer relationship as a main process.

The arrival rate analyzing module (32) derives an arrival rate (AR) that is a difference between a reservation time and an arrival time. The arrival rate analyzing module (32) derives an arrival rate (AR) satisfying the following equation 1.

AR=πᵣₜ(eᵢ)−πₐ(π_{trace}(1)) [Equation 1]

Wherein, πᵣₜ(eᵢ) is a reservation time, and πₐ(π_{trace}(1)) is a working time when a patient who arrives at the hospital firstly performs.

The hospital has a reservation system, thus the arrival rate analyzing module (32) derives an actual arrival rate of the patient by using the reservation information of the patient. In the reservation system of the hospital, there are reservation slots at each particular time in each session established by each department professor. Each of the reservation slots has a fixed number. When the fixed number is not exceeded, the patient may reserve an outpatient consultation by selecting the reservation slot for the particular time. Thus, it is possible to obtain the information how much the patient visits each reservation slot by analyzing the average number of scheduled patients at the reservation time of each doctor.

The arrival rate analyzing module (32) analyzes the time when the patient visits to the hospital on the basis of the reservation time. In the case of the hospital information system, the time history of the patient's visit is not saved. Thus, it is assumed that the time history of a working the patient who arrives at the hospital firstly performs as the visit history, and then the patient's reservation time and the time of the first working are calculated. The result is defined as the patient's hospital visiting time compared to the reservation time, and then the arrival rate is derived.

The working time analyzing module (33) derives a working time for a patient from the log data. In the hospital, there are a variety of work such as receipt, treatment, treatment receipt, inspection, inspection receipt, or the like. In general, the work such as treatment or inspection has the long required time (waiting time+processing time), on the contrary, the work such as treatment receipt or inspection receipt has the short required time. However, the hospital information system saves only the end time of each work, thus it is difficult to separate the work as the waiting time and the processing time. In other words, the total required time of work can be calculated, but the processing time of each work cannot be easily calculated.

In the patient's point of view, the processing time of only treatment cannot be calculated due to including the waiting time because the pre-work of treatment that is the time from after treatment receipt to treatment is calculated. However, in the doctor's point of view, the processing time of only treatment can be calculated. The working time analyzing module (33) derives an operation time (OT), and the operation time (OT) satisfies the following equation 2.

OT=πₑₜ(c_{dk})−πₑₜ(c_{dj}) [Equation 2]

Wherein, πₑₜ(c_{dk}) is the ‘d’ operation processing time against the ‘k’ patient, πₑₜ(c_{dj}) is the ‘d’ operation processing time against the ‘j’ patient, and the ‘j’ patient is a patient treated just before the ‘k’ patient.

The working time analyzing module (33) derives a waiting time (WT) that is a patient's waiting time for the treatment, and the waiting time (WT) satisfies the following equation 3.

WT=πₑₜ(c_{dj})−πₑₜ(c_{ck}) [Equation 3]

Wherein, πₑₜ(c_{dj}) is the ‘d’ operation processing time against the ‘j’ patient, πₑₜ(c_{ck}) is the ‘c’ operation processing time against the ‘k’ patient, the ‘c’ operation is an operation performed to the ‘k’ patient just before the ‘d’ operation, and the ‘j’ patient is a patient to whom the ‘d’ operation is performed just before the ‘k’ patient. Wherein the ‘d’ operation may be treatment, and the ‘c’ operation may be treatment receipt.

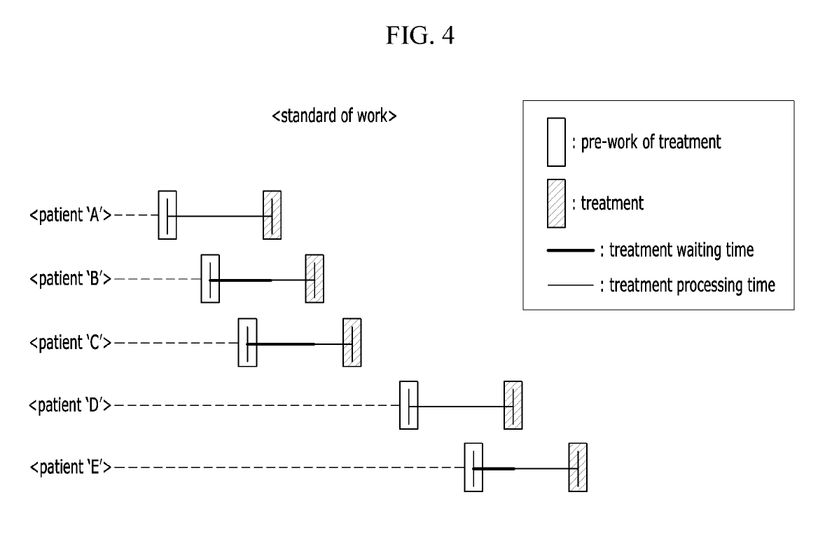

Referring to FIG. 4, there is a log data of the end time of patient's pre-work of treatment and treatment. In case of the first patient ‘A’ and the fourth patient ‘D’, there are no patients receiving treatment prior to ‘A’ or ‘D’. Thus, there is no waiting time. Thus, the total treatment time is the processing time. In case of the remaining patients, the treatment processing time is calculated by the difference between the end time of his treatment and the patient's treatment prior to him. In addition, the rest of the time except for the processing time from the total required time is the waiting time.

That is, the treatment time is the value calculated by subtracting the treatment end time of the just before the patient from the treatment end time of the patient. The waiting time is the value calculated by subtracting the prior working end time of the patient from the treatment end time of the just before the patient. Accordingly, the working time analyzing module (33) may precisely derive the treatment time and the waiting time through the Equation 2 and the Equation 3 stated above.

The worker analyzing module (34) analyzes the process in the worker's point of view. The worker analyzing module (34) derives a relationship between the workers and analyzes a correlation between the worker and the work. The worker analyzing module (34) may analyze whether a particular work is performed by any worker by analyzing the work performed by each worker. At this time, the relevance is calculated by measuring the distance between the work and the worker through the Pearson correlation coefficient, and then an analysis of how each worker belonging to a certain department and how the department should do may be performed by applying a limit value.

The process simulation modeling unit (40) generates a hospital process simulation model based on the result analyzed in the data analyzing unit (30). The derived process is used to form a main workflow in the simulation model, and the arrival rate distribution is used when applying the distribution of the number of patients per a reservation slot and the hospital visiting time compared with the reservation time to the simulation model.

Furthermore, the information of the working time is used as the demand time and the processing time which are analyzed as each work, and the worker information is applied to the each work's assigned work and the working transfer relationship between workers.

To evaluate the accuracy of the simulation model, a simulation model was analyzed based on an actual event log of ‘A’ hospital located in the Bundang. The purpose of the presented simulation model was to determine the treatment waiting time of patients received treatment from the ‘G’ doctor and reduce the waiting time. Analysis for the simulation were made by consultation with the hospital staff as well as information system in the hospital. Total number of the patients used in the case study was about 12 million, and total number of the event used in the case study was about 70. After extraction of the event log on the patient received treatment from the ‘G’ outpatient doctor, the needed data was identified by using the data pre-processing unit (20). The data pre-processing unit (20) excluded the data of patients corresponding to the upper or lower 5% based on the total amount of time spent on the hospital from the analysis. Furthermore, the data pre-processing unit (20) excluded the record of patients received other treatments rather than the treatment performed by the ‘G’ doctor in the department of endocrinology. Moreover, the data pre-processing unit (20) integrated various works that occur at the same time. For example, even though the patient's receipt was performed at one time, but the frequency of receipt was duplicated in the system. Thus, the duplicated data was removed.

The data analyzing unit (30) performed analysis except for the worker analysis. There is no need to analyze worker since the doctor is limited as one. The outpatient treatment of the ‘G’ doctor has a complicated spaghetti process as shown in FIG. 3A. The process as shown in FIG. 3B was derived by extracting more than 500 times of working transfer relationship in order to derive the process. The process in the simulation model are consisted of hospital visits, treatment receipt, treatment, treatment reservation, receipt, prescription, and returning home, and these steps are performed in the order of steps.

The arrival rate analyzing module (32) presents an analysis result of the number of patients per a reservation slot. The reservation slot of the ‘G’ doctor had a time interval of 10 minutes, so a total of 19 reservation slots were made from 9:00 to 12:00 per one day. The average 4.26 people were reserved per a slot, the maximum number was 12, the minimum number was 1, and the intermediate number was 5. Looking at the patient type, the 0.45 people reserved the first treatment per a slot, the 3.75 people reserved the second treatment per a slot, and the 0.1 people were new patients. Looking at the time, the new patient was mostly present in the initial slot. Especially, at 11:30, there were a large number of patients.

Moreover, the arrival rate analyzing module (32) analyzed the patient's hospital visiting time based on the treatment reservation time. As a result, it was found that the patient visited before overall average of 7.52 minutes. Furthermore, 759 patients who were about 65% of 1160 patients visited before average 23.15 minutes than the treatment reservation time, and there was a patient who visited before maximum 131 minutes. On the contrary, 401 patients visited after 22.08 minutes than the treatment reservation time, and there was a patient who visited after maximum 165 minutes.

Looking at the distribution, it was found that the most patients visited before or after the treatment reservation time and approximately 22% of total patients visited the hospital within 10 minutes based on the treatment reservation time. Moreover, the distribution had a similar distribution with a normal distribution. The number of patients per a reservation slot and the distribution of hospital visiting time were directly applied to the simulation. Since the empirical distribution is applied, the results more accurate than the conventional method utilizing the parametric distribution may be obtained.

Finally, the time aspect analysis was performed to put the time information relating to each work to the simulation model. Referring to Table 1 below, the purpose of the simulation was to understand the change of the treatment waiting time, thus the processing time and the waiting time were separated only for the treatment work, and the total time was directly used for other works. According to the calculation method for the processing time described before, it were found that the total treatment processing time was average 3.35 minutes and the intermediate value was 2.68 minutes. The reason for the difference between the average value and the intermediate value was that the doctor temporarily paused the outpatient treatment due to doctor's relaxation during between treatments or doctor's rounds. Therefore, the intermediate value of the treatment processing time was applied to the creation of the simulation model. For other works rather than the treatment, the total required time including the waiting time and the processing time was applied thereto.

TABLE 1
The result of time aspect analysis

| | | | Total required time | | | |
|---|---|---|---|---|---|---|
| | Treat- | | (treatment + waiting) | | | |
| | ment | Treatment | Issue of | Treat- | | |
| (Unit: | waiting | Processing | prescrip- | ment | Treat- | Re- |
| minute) | time | time | tion | receipt | ment | ceipt |
| Average | 34.43 | 3.35 | 0.19 | 1.11 | 3.29 | 5.99 |
| Inter- | | 2.68 | 0.15 | 0.00 | 1.57 | 3.96 |
| mediate | | | | | | |
| Minimum | | 0.00 | 0.00 | 0.00 | 0.00 | 0.00 |
| Maximum | | | 9.27 | 73.12 | 69.95 | 103.87 |
| Standard | | | 0.42 | 5.66 | 6.44 | 7.79 |
| deviation | | | | | | |

The created simulation model was based on the day, and the simulation model was consisted of total of a total of 19 reservation slots from 9:00 a.m. to 12:00 p.m. About 80 patients were treated by the simulation model. The analysis result of three point of view derived from the data analyzing unit (30) was directly applied. The record of the treatment processing time, the treatment waiting time, the on-time treatment waiting time, and the treatment end time were used for an evaluation of the simulation model.

The result of 200 times simulation was shown in Table 2. The average of the treatment waiting time was 36.41 minutes, and the average of the reservation waiting time was 31.36 minutes. This result means that the simulation was made well because the 36.41 minutes has only the 5.4% error compared with 34.43 minutes of the actual data, and the 31.36 minutes has only the 2% error compared with 32 minutes of the actual data.

TABLE 2

| | (Unit: minute) | | |
|---|---|---|---|
| | Treatment | Reservation | Treatment |
| | waiting time | waiting time | end time |
| Average | 35.04 | 30.38 | 12:54:28 PM |
| LCL(95%) | 32.75 | 28.09 | 12:51:11 PM |
| UCL(95%) | 37.33 | 32.66 | 12:57:44 PM |
| Minimum | 5.00 | 4.06 | 12:10:00 PM |
| Maximum | 94.51 | 83.55 | 14:01:35 PM |
| Standard deviation | 16.44 | 16.37 | 23.48 |
| Actual result of the | 34.43 | 31.13 | 12:48:54 PM |
| event log | | | |

Based on the created model, the accuracy of the model was evaluated by changing the three environments and simulating. First, we set the environment in which the hospital's sales increased to an appropriate level by increasing the number of patients per each slot, implemented simulation 100 times, and then derived the results by utilizing the statistical techniques.

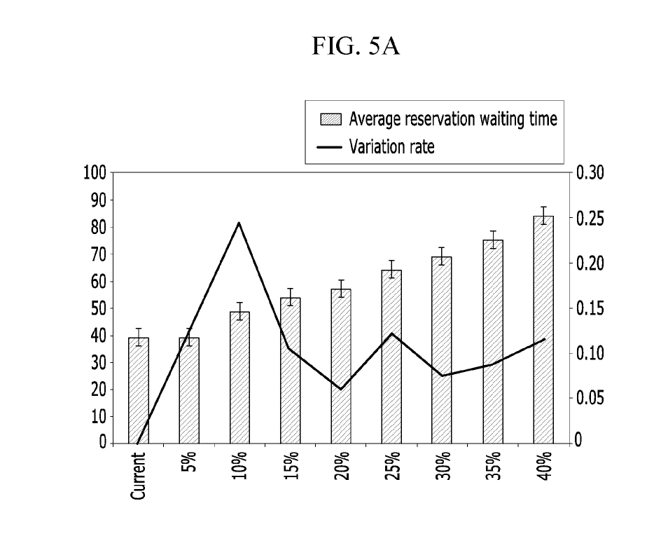

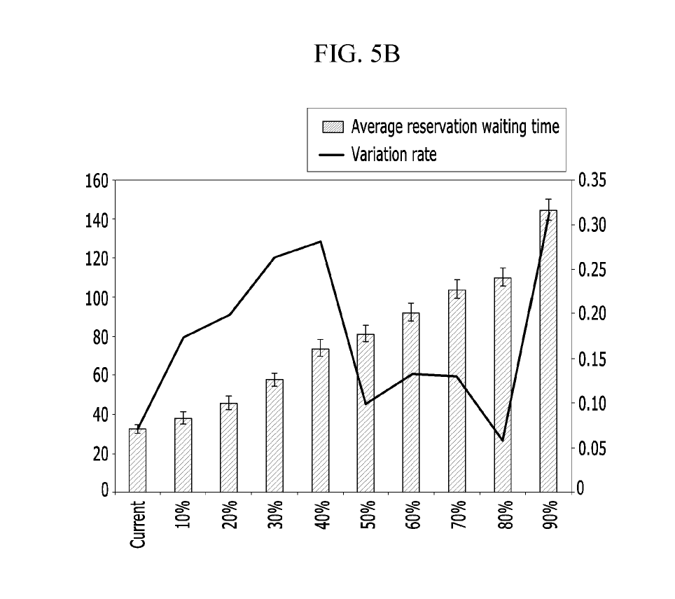

The waiting time and the treatment end time were identified by increasing the number of outpatient patients per the reservation slot by 5%. The respective changes were identified by increasing the number of patients from the current situation by maximum 40%. The simulation results based on the change of the number of patients was shown in FIG. 5A. In general, the treatment waiting time was increased as the number of patients increased. The on-time treatment waiting time and the treatment end time also followed the same pattern. Among these, the treatment waiting time was highly increased when increasing the number of patients by 10%.

Next, the environment in which the reservation slot was added was changed. The simulating was performed by extending the doctor's working time by adding a reservation slot to the current 19 slots after 12:00. A simulation in which the reservation slot became maximum 31 slots by increasing the number of slots up to 12 from the current situation was performed. The total average according to a patient type analyzed earlier was applied to the number of patients per slot. Thus, the 0.45 people of the first treatment, the 3.71 people of the second treatment, and the 0.10 people of the new patients were regularly added to the added slot. Like the case 1, as the number of slots generally increased, the treatment waiting time and the on-time treatment waiting time slightly increased. Additionally, an analysis result that when considering the variation rate the increasing slots by 3 or 4 more efficient than the increasing slots by 2 because the waiting time highly increased when the number of added slots was 2, 6, or 10 was presented.

Next, the environment was changed by extending the service time. A simulation analysis in which the service time was extended up to maximum 90% from the current situation was performed. In this case, it was also found that the waiting time increased according to increasing the treatment processing time. FIG. 5B indicates that service quality may be improved by increasing the treatment processing time in the current situation, but it also indicates that patients have complained because the waiting time significantly increases. Furthermore, as the treatment processing time increased, the total treatment time of the doctor significantly increased. In other words, if increasing the treatment processing time is extended without taking into account the number of patients, it makes the total treatment time of the doctor too long. Then, it causes problems to the doctor which may lead to a decline in service quality.

Hereinafter, the process simulation model discovery method according to an embodiment of the present invention will be described with reference to FIG. 2.

The process simulation model discovery method according to an embodiment of the present invention comprises: event log collecting (S101); data pre-processing (S102); data analyzing (S103); and process simulation modeling (S104).

The event log collecting (S101) collects an event log for a particular work recorded in the information system. A log data such as patient's reservation time, patient's time, operation time, injection time, treatment time, or the like is saved in the hospital information system. The event log collecting (S101) integrates the database stored in the hospital information system and creates a data for analysis (an event log).

The data pre-processing (S102) processes a data to enhance the accuracy and validity of the extracted log data. The data pre-processing (S102) may include missing value processing, outlier removing, and duplicate value removing.

When a data related to the worker's information is missed, the missing value processing may substitute a missed worker's ID for ID of the department by equally modifying the worker's ID and the ID of the department in which the worker is included. Moreover, the missing value processing may supplement the missed worker's ID by deriving a worker performing the operation at a given time in consideration of the correlation with other data.

The outlier removing removes data out of the upper and lower outlier criteria based on the working required time. The outlier criteria may be set in various ways according to type of the log data. For instance, a patent's data corresponding to the upper and lower 5% based on the total amount of time spent on hospital may be excluded from the analysis.

Due to the nature of the hospital, some patients may be admitted to hospital too early or visit the hospital twice or more. As a result, the total required time is maximized, and error may occur. The outlier removal module (22) removes the data causing the error to improve the accuracy of the log data.

The duplicate value removing removes a duplicate value if some works are duplicately recorded. For instance, in case of the work such as inspection, receipt, reservation, two or more works are performed and received at the same time in many cases. In such a case, the number of works recorded at the same time is increased, thus a data analysis may be difficult and the resulting noise may occur. Therefore, the duplicate value removing integrates these works and removes the duplicate values.

The data analyzing (S103) derives from a process from a log data and analyzes a working time. The data analyzing (S103) includes process deriving, arrival rate analyzing, working time analyzing, and worker analyzing.

The process deriving derives a process for a simulation from a log data. The process deriving may derive a process through an alpha mining method, a heuristic mining method, or the like. However, a mining technique directly designed is applied to the process deriving according to an embodiment of the present invention. The process deriving connects one log to another log through a movement line and sets up only logs connected with more than a predetermined number of a movement line as a process.

As described in FIG. 3A, a complex relation is derived when connecting logs in the order of time. Only important processes can be derived as shown in FIG. 3B by displaying only more than the predetermined limit standard of logs in the complex relation. FIG. 3B derives more than 500 times of working transfer relationship as a main process.

The arrival rate analyzing derives an arrival rate (AR) that is a difference between a reservation time and an arrival time. The arrival rate analyzing derives an arrival rate (AR) satisfying the following Equation 1.

AR=πᵣₜ(eᵢ)−πₐ(π_{trace}(1)) [Equation 1]

Wherein, πᵣₜ(eᵢ) is a reservation time, and πₐ(π_{trace}(1)) πᵣₜ(eᵢ) is a working time when a patient who arrives at the hospital firstly performs.

The hospital has a reservation system, thus the arrival rate analyzing derives an actual arrival rate of the patient by using the reservation information of the patient. In the reservation system of the hospital, there are reservation slots at each particular time in each session established by each department professor. Each of the reservation slots has a fixed number. When the fixed number is not exceeded, the patient may reserve an outpatient consultation by selecting the reservation slot for the particular time. Thus, it is possible to obtain the information how much the patient visits each reservation slot by analyzing the average number of scheduled patients at the reservation time of each doctor.

The arrival rate analyzing analyzes the time when the patient visits to the hospital on the basis of the reservation time. In the case of the hospital information system, the time history of the patient's visit is not saved. Thus, it is assumed that the time history of a working the patient who arrives at the hospital firstly performs as the visit history, and then the patient's reservation time and the time of the first working are calculated. The result is defined as the patient's hospital visiting time compared to the reservation time, and then the arrival rate is derived.

The working time analyzing derives a working time for a patient from the log data. In the hospital, there are a variety of work such as receipt, treatment, treatment receipt, inspection, inspection receipt, or the like. In general, the work such as treatment or inspection has the long required time (waiting time+processing time), on the contrary, the work such as treatment receipt or inspection receipt has the short required time. However, the hospital information system saves only the end time of each work, thus it is difficult to separate the work as the waiting time and the processing time. In other words, the total required time of work can be calculated, but the processing time of each work cannot be easily calculated.

In the *97 patient's point of view, the processing time of only treatment cannot be calculated due to including the waiting time because the pre-work of treatment that is the time from after treatment receipt to treatment is calculated. However, in the doctor's point of view, the processing time of only treatment can be calculated. The working time analyzing derives an operation time (OT), and the operation time (OT) satisfies the following equation 2.

OT=πₑₜ(c_{dk})−πₑₜ(c_{dj}) [Equation 2]

Wherein, πₑₜ(c_{dk}) is the ‘d’ operation processing time against the ‘k’ patient, πₑₜ(c_{dj}) is the ‘d’ operation processing time against the ‘j’ patient, and the ‘j’ patient is a patient treated just before the ‘k’ patient.

The working time analyzing derives a waiting time (WT) that is a patient's waiting time for the treatment, and the waiting time (WT) satisfies the following equation 3.

WT=πₑₜ(c_{dj})−πₑₜ(c_{ck}) [Equation 3]

Wherein, πₑₜ(c_{dj}) is the ‘d’ operation processing time against the ‘j’ patient, πₑₜ(c_{ck}) is the ‘c’ operation processing time against the ‘k’ patient, the ‘c’ operation is an operation performed to the ‘k’ patient just before the ‘d’ operation, and the ‘j’ patient is a patient to whom the ‘d’ operation is performed just before the ‘k’ patient. Wherein the ‘d’ operation may be treatment, and the ‘c’ operation may be treatment receipt.

The worker analyzing analyzes the process in the worker's point of view. The worker analyzing derives a relationship between the workers and analyzes a correlation between the worker and the work. The worker analyzing may analyze whether a particular work is performed by any worker by analyzing the work performed by each worker. At this time, the relevance is calculated by measuring the distance between the work and the worker through the Pearson correlation coefficient, and then an analysis of how each worker belonging to a certain department and how the department should do may be performed by applying a limit value.

The process simulation modeling (S104) generates a hospital process simulation model based on the result analyzed in the data analyzing (S103). The derived process is used to form a main workflow in the simulation model, and the arrival rate distribution is used when applying the distribution of the number of patients per a reservation slot and the hospital visiting time compared with the reservation time to the simulation model.

Furthermore, the information of the working time is used as the demand time and the processing time which are analyzed as each work, and the worker information is applied to the each work's assigned work and the working transfer relationship between workers.

Has been described with a preferred embodiment of the present invention over the above, the present invention is not limited thereto. The present invention may be modified or changed in many ways within the scope of the claims of the invention, the detailed description of one embodiment, and the accompanying drawings, and it is also natural that the modifications or changes fall within the scope of the present invention.

### DESCRIPTION OF REFERENCE NUMERALS

101: process simulation model discovery system
10: event log collection unit

| | |
|---|---|
| 20: data pre-processing unit | 21: missing value processing module |
| 22: outlier removal module | 23: duplicate value removal module |

| | |
|---|---|
| 30: data analyzing unit | 31: process derivation module |

| | |
|---|---|
| 32: arrival rate analyzing module | 33: working time analyzing module |

| | |
|---|---|
| 34: worker analyzing module | 40: process simulation modeling unit |

What is claimed is:

1. A process simulation model discovery system of outpatient consultation, comprising:
an event log collection unit which collects an event log data;
a data pre-processing unit which removes a duplicate value and an outlier from the log data;
a data analyzing unit which derives from a process from the log data and analyzes a working time; and
a process simulation modeling unit which generates a process simulation model,
wherein the data analyzing unit includes a process derivation module which derives a process corresponding to a work from a log data and a working time analyzing module which derives a working time for a patient from the log data.

2. The system of claim 1,
wherein the data pre-processing unit includes a missing value processing module which processes a missing value in which a data is missed, and the missing value processing module generates a missing value by modifying a worker's ID to be equal to an ID of department in which the worker is included.

3. The system of claim 1,
wherein the process derivation module connects one log to another log through a movement line and sets up only logs connected with more than a predetermined number of a movement line as a process.

4. The system of claim 1,
wherein the data analyzing unit includes an arrival rate analyzing module which derives an arrival rate (AR) that is a difference between a reservation time and an arrival time, and
the arrival rate analyzing module derives the arrival rate by using the following equation:
AR=πᵣₜ(eᵢ)−πₐ(π_{trace}(1)),
Wherein, πᵣₜ(eᵢ) is a reservation time, and πₐ(π_{trace}(1)) is a working time when a patient who arrives at the hospital firstly performs.

5. The system of claim 1,
wherein a working time analyzing module derives an operation time (OT) for a patient, and the operation time (OT) satisfies the following equation:
OT=πₑₜ(c_{dk})−πₑₜ(c_{dj}),
Wherein, πₑₜ(c_{dk}) is the ‘d’ operation processing time against the ‘k’ patient, πₑₜ(c_{dj}) is the ‘d’ operation processing time against the ‘j’ patient, and the ‘j’ patient is a patient treated just before the ‘k’ patient.

6. The system of claim 1,
wherein the working time analyzing derives a waiting time (WT) that is a patent's waiting time for the treatment, and the waiting time (WT) satisfies the following equation:
WT=πₑₜ(c_{dj})−πₑₜ(c_{ck}),
Wherein, πₑₜ(c_{dj}) is the ‘d’ operation processing time against the ‘j’ patient, πₑₜ(c_{ck}) is the ‘c’ operation processing time against the ‘k’ patient, and the ‘c’ operation is an operation performed to the ‘k’ patient just before the ‘d’ operation.

7. A process simulation model discovery method of outpatient consultation, comprising:
event log collecting which collects an event log data;
data pre-processing which removes a duplicate value and an outlier from the log data;
data analyzing which derives from a process from the log data and analyze a working time; and
process simulation modeling which generates a process simulation model,
wherein the data analyzing includes process deriving which derives a process corresponding to a work from a log data and working time analyzing which derives a working time for a patient from the log data.

8. The method of claim 7,
wherein the data pre-processing includes a missing value processing which processes a missing value in which a data is missed, and the missing value processing generates a missing value by modifying a worker's ID to be equal to an ID of department in which the worker is included.

9. The method of claim 7,
wherein the process deriving connects one log to another log through a movement line and sets up only logs connected with more than a predetermined number of a movement line as a process.

10. The method of claim 7,
wherein the data analyzing includes an arrival rate analyzing which derives an arrival rate (AR) that is a difference between a reservation time and an arrival time, and
the arrival rate satisfies the following equation:
AR=πᵣₜ(eᵢ)−πₐ(π_{trace}(1)),
Wherein, πᵣₜ(eᵢ) is a reservation time, and πₐ(π_{trace}(1)) a working time when a patient who arrives at the hospital firstly performs.

11. The method of claim 7,
wherein a working time analyzing derives an operation time (OT), and the operation time (OT) satisfies the following equation:
OT=πₑₜ(c_{dk})−πₑₜ(c_{dj}),
Wherein, πₑₜ(c_{dk}) is the ‘d’ operation processing time against the ‘k’ patient, πₑₜ(c_{dj}) is the ‘d’ operation processing time against the ‘j’ patient, and the ‘j’ patient is a patient treated just before the ‘k’ patient.

12. The method of claim 7,
wherein the working time analyzing derives a waiting time (WT), and the waiting time (WT) satisfies the following equation:
WT=πₑₜ(c_{dj})−πₑₜ(c_{ck}),
Wherein, πₑₜ(c_{dj}) is the ‘d’ operation processing time against the ‘j’ patient, πₑₜ(c_{ck}) is the ‘c’ operation processing time against the ‘k’ patient, and the ‘c’ operation is an operation performed to the ‘k’ patient just before the ‘d’ operation.
